(19) United States
(12) Patent Application Publication
(10) Pub. No.: US 2010/0107644 A1
(43) Pub. Date: May 6, 2010

(54) COMBUSTION PRE-CHAMBER

(76) Inventor: Nigel Wilbraham, West Midlands (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/593,705

(22) PCT Filed: Mar. 27, 2008
(86) PCT No.: PCT/EP2008/053653

§ 371 Date: Sep. 29, 2009

(30) Foreign Application Priority Data
Mar. 30, 2007 (EP) 07006732.7

(51) Int. Cl. F02C 7/22

(52) U.S. Cl. 60/748; 60/752

(57) ABSTRACT

A combustion pre-chamber including an upstream end and a downstream end is provided. The combustion pre-chamber includes a transition channel formed by a wall, the wall extending between the upstream end and the downstream end, and at least one flow trip arranged on the wall and tapering in height and width to the downstream end. Also provided are a burner assembly including a combustion pre-chamber, and a gas turbine engine.

This application is the US National Stage of International Application No. PCT/EP2008/053653, filed Mar. 27, 2008 and claims the benefit thereof. The International Application claims the benefits of European Patent Office application No. 07006732.7 EP filed Mar. 30, 2007, both of the applications are incorporated by reference herein in their entirety.

### FIELD OF THE INVENTION

The invention relates to a combustion pre-chamber, a burner assembly and a gas turbine engine.

### BACKGROUND OF THE INVENTION

Air pollution is a worldwide concern and many countries have enacted stricter laws further limiting the emission of pollutants from gas turbine engines or offer fiscal or other benefits for environmentally sound installations. Although the prior techniques for reducing the emissions of NOₓ from gas turbine engines are steps in the right direction, the need for additional improvements remains.

There are two main measures by which reduction of the temperature of the combustion flame can be achieved. The first is to use a fine distribution of fuel in the air, generating a fuel/air mixture with a low fuel fraction. The thermal mass of the excess air present in the reaction zone of a lean premixed combustor absorbs heat and limits the temperature rise of the products of combustion to a level where thermal NOₓ is not excessively formed. The second measure is to provide a thorough mixing of fuel and air prior to combustion. The better the mixing, the fewer regions exist where the fuel concentration is significantly higher than average, the fewer the regions reaching higher temperatures than average, the lower the fraction of thermal NOₓ will be.

Usually the premixing of fuel and air in a gas turbine engine takes place by injecting fuel into an air stream in a swirling zone of a combustor which is located upstream from the combustion zone. The swirling produces a mixing of fuel and air before the mixture enters the combustion zone.

U.S. Pat. No. 6,152,726 describes a burner, comprising an upstream rotation generator, a mixing section downstream from the upstream rotation generator, at least one transition channel and a mixing pipe downstream from the transition channels and at least one rotation generator on the mixing pipe end side.

Although this kind of burner provides good results with regard to good pollutant emissions, there is still space for improvements.

### SUMMARY OF THE INVENTION

An object of the invention is to provide an improved combustion pre-chamber allowing for a better pre-mixing of gaseous fuel and compressor air to provide a homogeneous fuel/air mixture and thereby reduce formation of NOₓ. Another objective is to provide a burner assembly with an improved combustion pre-chamber. Still another objective is to provide a gas turbine engine with an improved burner.

These objectives are achieved by the claims. The dependent claims describe advantageous developments and modifications of the invention.

An inventive combustion pre-chamber comprises flow trips arranged on the wall of the pre-chamber to promote fuel/air mixing. The swirling flow inside the pre-chamber encounters these flow trips. The flow trips create vortices that are positioned on the leeward side of the flow trips and have axes parallel to the respective flow trip. This means the vortices will have “axes” extending towards the exit lip at the downstream end of the pre-chamber.

Ordinarily, flow trips would not be placed on the wall of a pre-chamber due to flashback risk. Flow trips, especially at the end of the pre-chamber, could generate flame attachment points onto the pre-chamber wall which in turn could lead to a burn through. The inventive pre-chamber therefore comprises flow trips tapering in height and width to the downstream end of the combustion pre-chamber since the flashback risk is mitigated by the reduction in the trip height to near zero at the exit lip at the downstream end of the pre-chamber. Since the flow trip height and width decreases towards the exit of the pre-chamber the associated vortex generation decreases too and so decreases the vortex near the pre-chamber exit lip, preventing a flame attaching to this vortex or ‘flashing back’ onto the vortex.

In an advantageous embodiment, the air flow around the pre-chamber, the pre-chamber being in the machine centre-casing plenum, can be used to still further mitigate the risk of flashback by injecting compressor air through effusion holes. Effusion holes can be arranged in the wall of the transition channel of the combustion pre-chamber and in the flow trips, respectively. They provide additional flashback protection by admitting air into the boundary layer to form a film on the wall of the pre-chamber boundary layer. In the film, the fuel air mixture is weakened to below the flammability limit.

It is particularly advantageous when effusion holes are arranged on the flow trip edge where they provide flashback protection where flashback is most likely to occur.

Additionally, the amount of air can be locally increased near potential flashback risk areas such as the trailing edge of a flow trip—by increasing the number of effusion holes in those locations.

Regarding injection openings in the transition channel and especially on the flow trips, various placements are possible. However, the back pressure on the fuel injection for a windward injection system might be unfavourable. It is therefore advantageous to have the fuel injection openings arranged on a leeward side of the flow trips to inject fuel downstream in the vortices created by the flow trip.

In a further advantageous embodiment, fuel injection will occur near the upstream end of the transition channel to inject the fuel into the upstream end of the vortex. Injecting further downstream increases the flashback risk.

It is particularly advantageous when the flow trips are perpendicular to the main flow efflux such that a flow trip edge follows a line defined by a main swirling flow efflux front near the pre-chamber wall. If, for example, the swirling flow traces a clockwise helical path around the pre-chamber, the flow trips would be arranged on the wall of the pre-chamber with an anti-clockwise helical orientation.

By such a design a better pre-mixing of fuel, especially gaseous fuel, with compressor air and a homogeneous fuel/air mixture is achieved to reduce formation of NOₓ.

### BRIEF DESCRIPTION OF THE DRAWINGS

The invention will now be further described with reference to the accompanying drawings in which:

FIG. 1 represents a view of the inventive combustion pre-chamber from the swirler to the combustor,

FIG. 2 is a closer view on the encircled section of FIG. 1 showing flow trip details,

FIG. 3 is a perspective view of an inventive combustion pre-chamber with helical flow trips,

FIG. 4 is a perspective view of an inventive combustion pre-chamber with non-helical flow trips, and

FIG. 5 shows an exploded view of part of a burner assembly.

In the drawings like references identify like or equivalent parts.

### DETAILED DESCRIPTION OF THE INVENTION

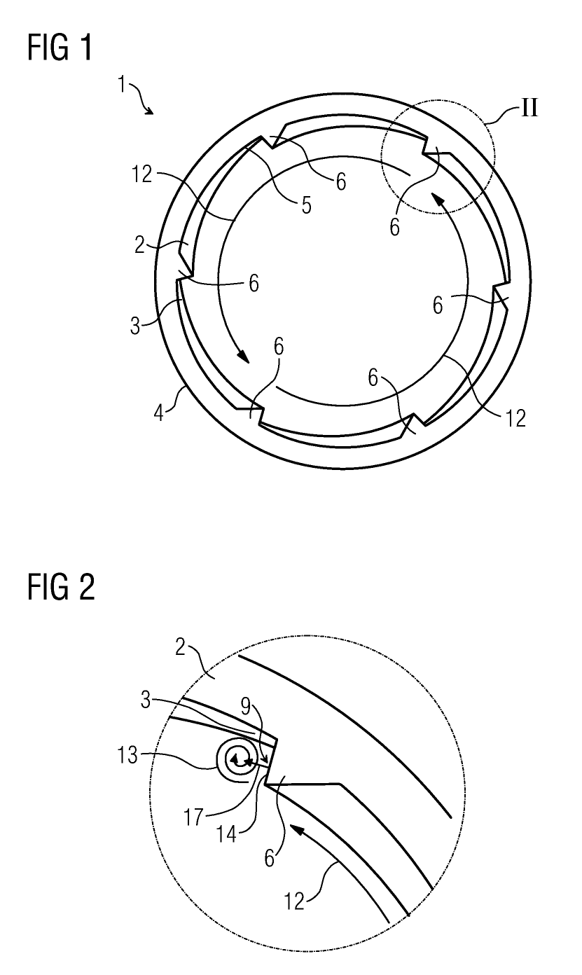

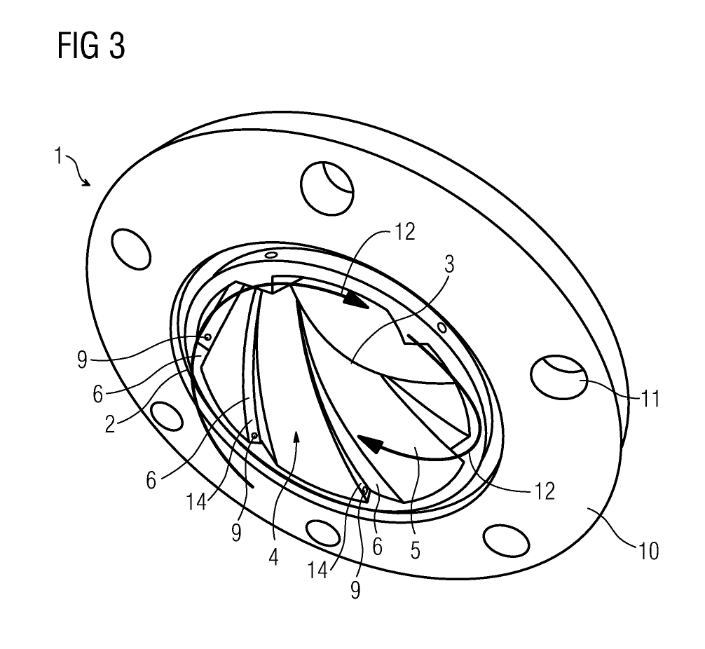

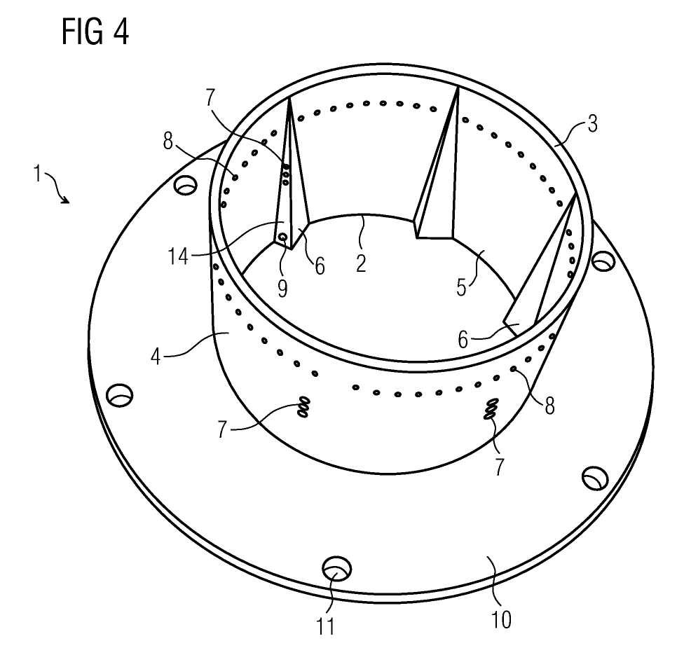

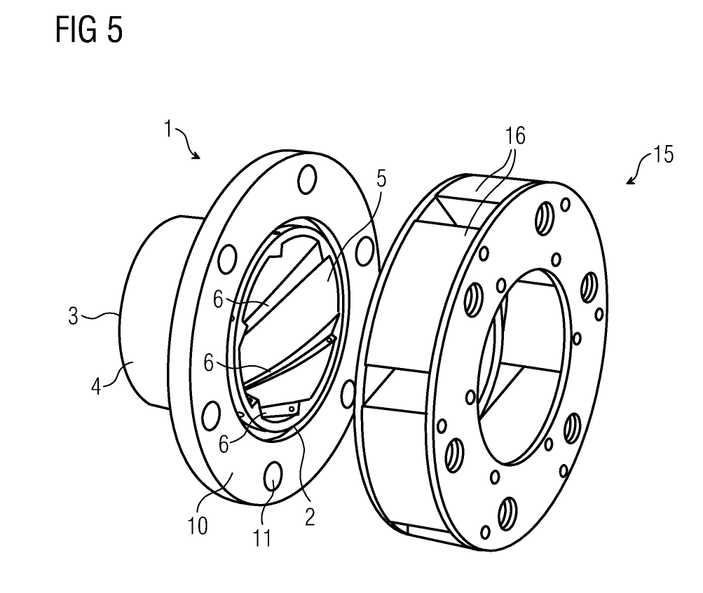

FIG. 1 is a view of an embodiment of the inventive combustion pre-chamber 1 looking onto the upstream end 2 of the combustion pre-chamber 1 in downstream direction. The wall 5 of the combustor pre-chamber 1 is tubular and the flow trips 6 are helical and taper out at a downstream end 3 of the combustion pre-chamber 1 (the tapering out can better be seen in FIGS. 3 and 4). The cross-section of the flow trips 6 is triangular. The swirl of the main efflux of the fuel-air mixture 12 created in the swirler assembly 15 (see FIG. 5) is indicated by arrows.

FIG. 2 is a closer view on the encircled section of the combustor pre-chamber 1 shown in FIG. 1. The main fuel/air mixture 12 efflux encounters the flow trip 6. The flow trip 6 creates a vortex 13 that is positioned on the leeward side 14 of the flow trip 6. Additional fuel is injected through fuel injection openings 9 into the vortex 13 created by the flow trip 6.

FIG. 3 shows the perspective view of an embodiment of the inventive combustion pre-chamber 1 with helical flow trips 6 arranged on the transition channel 4 formed by a wall 5 and tapering out at the downstream end 3 of the combustion pre-chamber 1. Fuel injection openings 9 are arranged on a leeward side 14 of the helical flow trips 6. With this combustor pre-chamber 1 design the direction of rotation of the main efflux of the fuel/air mixture 12 created in a swirler assembly 15 (see FIG. 5) would be as indicated by the arrows. A flange 10 is arranged at the upstream end 2 of the combustion pre-chamber 1 having bolt holes 11 arranged in it. The bolt hole 11 pattern allows for mounting the combustion pre-chamber 1 onto a swirler assembly 15.

With reference to FIG. 4, a perspective view in essentially upstream direction on the downstream end 3 of an embodiment of the combustion pre-chamber 1 with non-helical flow trips 6 is shown. As in FIG. 3, a flange 10 with bolt holes 11 is arranged at the upstream end 2 of the combustion pre-chamber 1 connecting to the transition channel 4. The non-helical flow trips 6 have a triangular cross-section and taper out at the downstream end 3 of the wall 5 of the transition channel 4 of the combustion pre-chamber 1. Fuel injection openings 9 are arranged on the flow trips 6 close to the upstream end 2 of the combustion pre-chamber 1. Further downstream, first and second effusion holes 7,8 are arranged both in the flow trips 6 and in the wall 5 of the combustion pre-chamber 1.

With reference to FIG. 5 parts of a burner assembly are shown in an exploded view. The burner assembly comprises a swirler assembly 15 and a combustion pre-chamber 1. The orientation of the vanes 16 in the swirler assembly 15 is such that the fuel injection openings 9 in the combustion pre-chamber 1 are on a leeward side 14 of the main efflux of the fuel/air mixture 12 created in the swirler assembly 15.

1-17. (canceled)

18. A gas turbine combustion pre-chamber including an upstream end and a downstream end, the combustion pre-chamber comprising:
a transition channel formed by a wall, the wall extending between the upstream end and the downstream end;
a flow trip arranged on the wall and tapering in a height and a width to the downstream end; and
a plurality of effusion holes arranged in the wall and/or on the flow trip.

19. The gas turbine combustion pre-chamber as claimed in claim 18, wherein the wall is tubular in shape.

20. The gas turbine combustion pre-chamber as claimed in claim 18, wherein the flow trip extends between the upstream end and the downstream end.

21. The gas turbine combustion pre-chamber as claimed in claim 18, wherein the flow trip is helical in shape.

22. The gas turbine combustion pre-chamber as claimed in claim 18, wherein a profile/cross-section of the flow trip is triangular.

23. The gas turbine combustion pre-chamber as claimed in claim 18, wherein a fuel injection opening is arranged on the flow trip.

24. The gas turbine combustion pre-chamber as claimed in claim 23, wherein the fuel injection opening is arranged closer to the upstream end than to the downstream end.

25. The gas turbine combustion pre-chamber as claimed in claim 23, further comprising a plurality of first effusion holes arranged in the wall.

26. The gas turbine combustion pre-chamber as claimed in claim 25, wherein the plurality of first effusion holes are arranged closer to the downstream end than to the upstream end.

27. The gas turbine combustion pre-chamber as claimed in claim 25, wherein a plurality of second effusion holes are arranged on the flow trip.

28. The gas turbine combustion pre-chamber as claimed in claim 27, wherein the plurality of second effusion holes are arranged downstream of the fuel injection opening.

29. The gas turbine combustion pre-chamber as claimed in claim 18, further comprising a flange.

30. A gas turbine burner assembly, comprising:
a gas turbine combustion pre-chamber, comprising:
a transition channel formed by a wall, the wall extending between the upstream end and the downstream end,
a flow trip arranged on the wall and tapering in a height and a width to the downstream end, and
a plurality of effusion holes arranged in the wall and/or on the flow trip.

31. A gas turbine burner assembly as claimed in claim 30, further comprising a flange,
wherein the gas turbine combustion pre-chamber is arranged downstream of a swirler assembly, and
wherein the gas turbine combustion pre-chamber is connected to the swirler with the flange.

32. The gas turbine burner assembly as claimed in claim 30, wherein a fuel injection opening is arranged on the flow trip.

33. A gas turbine burner assembly as claimed in claim 32, wherein the fuel injection opening is arranged on a leeward side of the flow trip.

34. The gas turbine burner assembly as claimed in claim 30, wherein a first direction of rotation of the flow trip is in opposition to a second direction of rotation of a main efflux created by the swirler assembly.

35. A gas turbine engine, comprising:
a gas turbine burner assembly, comprising:
a gas turbine combustion pre-chamber, comprising:
a transition channel formed by a wall, the wall extending between the upstream end and the downstream end,
a flow trip arranged on the wall and tapering in a height and a width to the downstream end, and
a plurality of effusion holes arranged in the wall and/or on the flow trip.

36. A gas turbine engine as claimed in claim 35,
wherein the gas turbine burner assembly further comprises a flange,
wherein the gas turbine combustion pre-chamber is arranged downstream of a swirler assembly, and
wherein the gas turbine combustion pre-chamber is connected to the swirler with the flange.

37. The gas turbine engine as claimed in claim 35, wherein a first direction of rotation of the flow trip is in opposition to a second direction of rotation of a main efflux created by the swirler assembly.
